(19) United States
(12) Patent Application Publication
(10) Pub. No.: US 2003/0085796 A1
(43) Pub. Date: May 8, 2003

(54) Electronic door lock for a fuel dispenser

(75) Inventor: Ervin M. Smith, Monroe, IN (US)

Correspondence Address: RANDALL J. KNUTH P.C., 3510-A STELLHORN ROAD, FORT WAYNE, IN, 46815-4631, US

(73) Assignee: Tokheim Corporation

(21) Appl. No.: 10/026,211

(22) Filed: Dec. 19, 2001

Related U.S. Application Data
(60) Provisional application No. 60/332,876, filed on Nov. 6, 2001.

(51) Int. Cl. H04Q 1/00; G05B 19/00

(52) U.S. Cl. 340/5.7; 340/5.4

(57) ABSTRACT

A method and apparatus for a fuel dispenser having an electronic door lock used to control access to the interior of the fuel dispenser. Upon entering a valid authorization code, a switching device creates an electrical connection between the locking device and the power source causing the locking device to retract and therefore unlock the fuel dispenser door.

### BACKGROUND OF THE INVENTION

1. Field of the Invention

The present invention relates to a fuel dispenser having an electronic door lock used to control access to the interior of the fuel dispenser.

2. Description of the Related Art

The use of locks on fuel dispenser doors is well known in the art. A problem is that the lock has a corresponding key used to unlock the fuel dispenser door. The key can be copied and distributed to many people that work on the fuel dispenser, and therefore, it is difficult to keep track of whom has access to the fuel dispenser. The key may be stolen and people not authorized to access the fuel dispenser may then do so. Additionally, there is a possibility of water leakage through the keyhole on the fuel dispenser door causing internal problems for the fuel dispenser. Finally, a person can break the lock by drilling through the keyhole and thereby access the interior of the fuel dispenser without authorization. The present invention solves these problems.

### SUMMARY OF THE INVENTION

The invention, in one form thereof, comprises a fuel dispenser having a door that is used to access the interior of the fuel dispenser. Either the housing of the fuel dispenser or the door has a locking device. The other has a receiving member. The locking device has a connecting member and the connecting member is connected to a switch means. The switch means is connected to a power source. When the fuel dispenser door is locked, the connecting member from the locking device is inserted or latched in the receiving member. Once power is applied to the locking device, the connecting member retracts or is unlatched from the receiving member which unlocks the fuel dispenser door.

The invention, in another form thereof, comprises a fuel dispenser having two doors that are used to access the interior of a fuel dispenser. One of the two doors of the fuel dispenser has a locking device. The other door has a receiving member. The locking device has a connecting member, and the connecting member is connected to a power source. When the fuel dispenser is locked, the connecting member from the locking device is inserted in the receiving member of the door on the fuel dispenser. Once power is applied to the locking device, the connecting member retracts from the receiving member which unlocks the fuel dispenser doors.

A computer can be connected to the electronic door lock to store the time and date, as well as, information on who accessed the fuel dispenser. The computer would be connected to the switch means, which can be a keypad, and each time a proper authorization code is entered into the keypad, the switch means creates an electrical connection between the power source and the locking device. Each time the electrical connection is established, the computer stores the time, date, and authorization code of the person unlocking the fuel dispenser.

The invention, in yet another form thereof, comprises a method of using an electronic door lock with a fuel dispenser. There is a fuel dispenser with a housing, door, and a power source. The method includes locking the door by connecting a locking device to either the housing or the door. The locking device has a connecting member extending into a receiving member. The receiving member is located on whichever of the housing or the door that does not have the locking device. The locking device is connected to the power source. The method further includes unlocking the door using a switch means with the fuel dispenser for creating an electrical connection between the power source and the locking device causing the connecting member to retract from the receiving member.

An advantage of the present invention is that by eliminating keys, the chance of unauthorized entry into the interior of the fuel dispenser is minimized.

Another advantage of the present invention is that the computerized log file identifies the time and date, as well as, who accessed the interior of the fuel dispenser. This file can be used to ensure that the maintenance is attempted/completed on the fuel dispenser when it is scheduled to be attempted/completed.

A further advantage of the present invention is that by eliminating the keyhole on the outside of the fuel dispenser, water is not able to leak into the keyhole and effect the interior of the fuel dispenser.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic view of one embodiment of the present invention; and

FIG. 2 is a diagrammatic view of one embodiment of the present invention; and

FIG. 3 is a flow chart of one embodiment of the present invention.

Corresponding reference characters indicate corresponding parts throughout the several views. The exemplification set out herein illustrates a preferred embodiment of the invention, in one form, and such exemplification is not to be construed as limiting the scope of the invention in any manner.

### DETAILED DESCRIPTION OF THE INVENTION

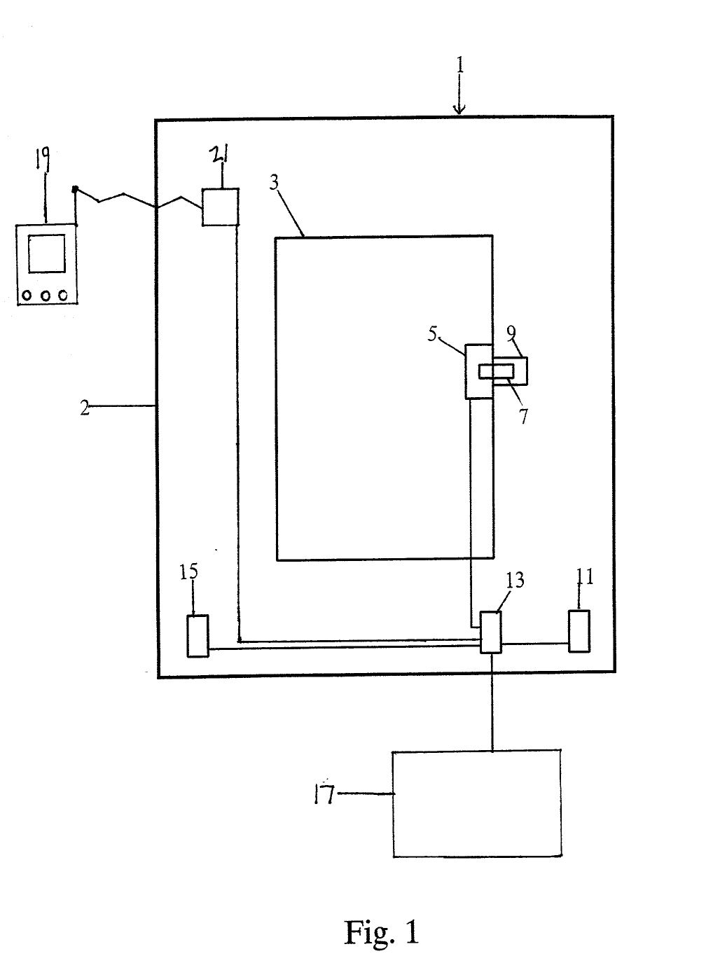

Referring now to the drawings and particularly to FIG. 1, there is shown a fuel dispenser having an electronic door lock used to restrict access to the interior of the fuel dispenser.

In accordance with the present invention, fuel dispenser 1 has a housing 2 and a door 3 attached to fuel dispenser 1. Door 3 is used for access to the interior of fuel dispenser 1. Door 3, in the preferred embodiment, is connected to housing 2 using a hinge; however, door 3 could be separate from housing 2 yet still a part of fuel dispenser 1.

A locking device 5 is used to prevent access from unauthorized people into the interior of fuel dispenser 1. Locking device 5 has a connecting member 7 that selectably extends into a receiving member 9. The mechanical inverse wherein connecting member 7 stays in the extended position and receiving member 9 engages and disengages with connecting member 7 can be used as well. Connecting member 7 can be, but is not limited to, a shaft or a throw. Receiving member 9 has an opening for engagement with connecting member 7 and upon engagement with connecting member 7, door 3 on fuel dispenser 1 is locked.

Locking device 5 can be located on either door 3 or housing 2. When locking device 5 is located on door 3, as shown in FIG. 1, receiving member 9 is located on housing 2. If locking device 5 is located on housing 2, then receiving member 9 would be located on door 3.

Locking device 5 includes in one form, a solenoid around the surface of connecting member 7. A plunger lock or any other type of locking device can be used, however, the solenoid around the surface of connecting member 7 is the preferred embodiment for actuating the connection. Locking device 5 is connected to a switch means 13, which in turn, is connected to a power source 11. Switch means 13 is used to either make or break the electrical connection between power source 11 and locking device 5.

Power source 11 can be a battery or other source of power. Power source 11 can be located in the interior of fuel dispenser 1 or outside of fuel dispenser 1. Also, power source 11 can use a battery backup in case the primary battery loses its charge, or if there is a power failure when power source 11 is using an outside electrical connection as its source of power.

Switch means 13 is preferably located within fuel dispenser 1, but does not have to be located within fuel dispenser 1. Switch means 13 is preferably a keypad wherein a person wanting to access the interior of fuel dispenser 1 would need to enter keystrokes to unlock door 3 of fuel dispenser 1. Furthermore, switch means 13 can be connected to a dedicated line. The other end of the dedicated line is connected to a remote location 17. This connection through the dedicated line allows door 3 on fuel dispenser 1 to be unlocked from remote location 17. Additionally, switch means 13 could be connected to a signal receiving device 21. A wireless device 19, such as a personal digital assistant, could be used to enter an authorized sequence of keystrokes and wireless device 19 sends a signal to signal receiving device 21 which activates switch means 13.

Locking device 5 is generally in the locked position, consisting of connecting member 7 extending into receiving member 9. To access the interior of fuel dispenser 1, keystrokes are entered into the keypad located on fuel dispenser 1. The keypad will compare the keystrokes with a list of authorized keystrokes and if the keystrokes entered into the keypad are on the authorized list of keystrokes, the keypad sends a signal to switch means 13 to create an electrical connection between power source 11 and locking device 5. The power from power source 11 is applied to the solenoid around connecting member 7 causing connecting member 7 to retract from receiving member 9. Locking device 5 can use a biasing means, such as a spring, to extend connecting member 7 into receiving member 9 once switch means 13 breaks the electrical connection between power source 11 and locking device 5. Other ways of extending connecting member 7 into receiving member 9 can be utilized as well.

Each person that is authorized to access the interior of fuel dispenser 1 is given a unique authorization code consisting of keystrokes. A computer 15 can be connected to switch means 13 and each time switch means 13 makes a connection between power source 11 and locking device 5, because authorized keystrokes are entered into the keypad, a signal is sent from switch means 13 to computer 15 so that computer 15 can create a log of the time, date, and person accessing fuel dispenser 1. The computer, for example, is an IBM-compatible computer running Microsoft Windows and having at least a 400 mhz processor. Other computers can be used as well depending on the space available in fuel dispenser 1 to store the computer. Computer 15 can either be located in the interior of fuel dispenser 1 or outside of fuel dispenser 1. The log in the form of a file can be saved to memory connected to computer 15, and/or the log can be printed directly to a printer. The log can also be displayed on a display connected to computer 15. For example, if a service person wants to access the interior of fuel dispenser 1, the service person enters their particular code on the keypad and upon entering a valid code, a signal is sent to computer 15 and that person's code is stored, printed, and/or displayed as well as the time and date that the person is entering fuel dispenser 1.

An intruder sensing device can also be placed within fuel dispenser 1 so that if there is an entry without using an authorized sequence of keystrokes, a signal will be sent to computer 15 and the entry will be added to the log of access times for fuel dispenser 1.

The present invention, in another form, comprises a fuel dispenser with two doors and having an electronic door lock on one door used to restrict access to the interior of the fuel dispenser.

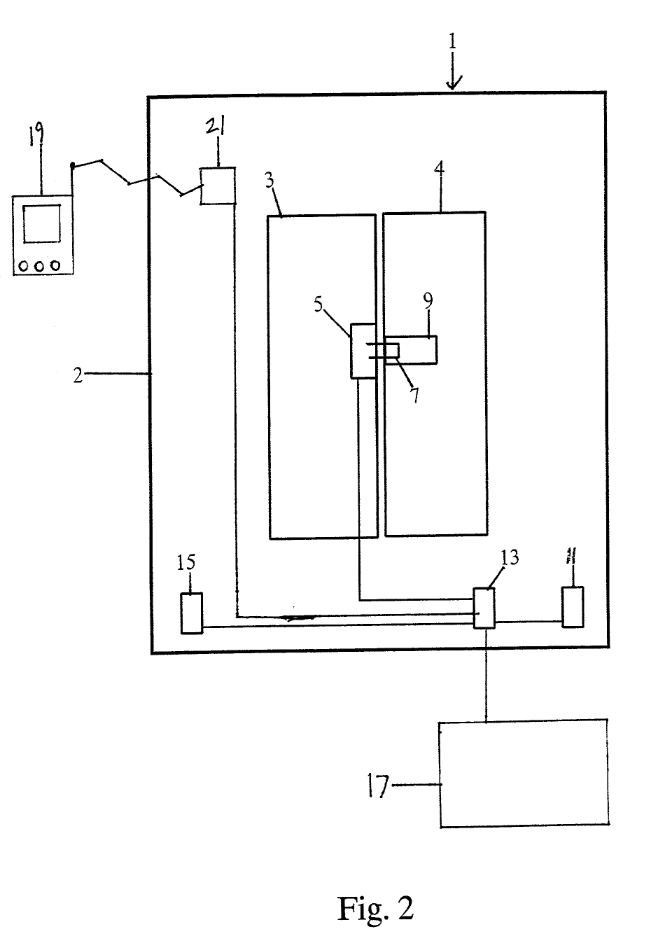

Turning now to FIG. 2, fuel dispenser 1 has a first door 3 and a second door 4 attached to fuel dispenser 1 for access to the interior of fuel dispenser 1. First door 3 and second door 4 are connected to housing 2 using hinges. However, first door 3 and second door 4 could be separate from housing 2, yet still a part of fuel dispenser 1.

A locking device 5 is used to prevent access from unauthorized people into the interior of fuel dispenser 1. Locking device 5 has a connecting member 7 that selectably extends into a receiving member 9. Receiving member 9 has an opening for engagement with connecting member 7 and upon engagement of connecting member 7, first door 3 and second door 4 on fuel dispenser 1 are locked. Locking device 5 can be located on either first door 3 or second door 4. If locking device 5 is located on first door 3, receiving member 9 is located on second door 4. If locking device 5 is located on second door 4, receiving member 9 is located on first door 3.

Locking device 5 includes in one form, a solenoid around the surface of connecting member 7. Locking device 5 is connected to a switch means 13, which in turn, is connected to a power source 11. Switch means 13 is used to either make or break the electrical connection between power source 11 and locking device 5.

Power source 11 can be a battery or other source of power. Power source 11 can be located in the interior of fuel dispenser 1 or outside of fuel dispenser 1. Also, power source 11 can use a battery backup in case the primary battery loses its charge, or if there is a power failure when power source 11 is using an outside electrical connection as its source of power.

Switch means 13 is preferably located within fuel dispenser 1, but does not have to be located within fuel dispenser 1. Switch means 13 is preferably a keypad wherein a person wanting to access the interior of fuel dispenser 1 would need to enter a valid sequence of keystrokes to unlock the doors of fuel dispenser 1. Furthermore, switch means 13 can be connected to a dedicated line. The other end of the dedicated line is connected to a remote location 17 such as a fueling station. This connection through the dedicated line allows doors 3 and 4 on fuel dispenser 1 to be unlocked from remote location 17. Additionally, switch means 13 could be connected to a signal receiving device 21. Using a wireless device 19, such as a personal digital assistant, a signal can be sent to signal receiving device 21 once an authorized sequence of keystrokes is entered into the wireless device 19 which in turn sends a signal to the switch means 13 so that switch means 13 is activated causing doors 3 and 4 to unlock.

Locking device 5 is generally in the locked position, consisting of connecting member 7 extending into receiving member 9. To access the interior of fuel dispenser 1, keystrokes are entered into the keypad located on fuel dispenser 1. The keypad compares the keystrokes entered to a list of authorized keystrokes and if the keystrokes entered into the keypad are one of the authorized keystrokes, a signal is sent to the switch means 13 to create an electrical connection between power source 11 and locking device 5. The power from power source 11 is applied to the solenoid around connecting member 7 causing connecting member 7 to retract from receiving member 9. Locking device 5 can use a biasing means to extend connecting member 7 into receiving member 9 once switch means 13 breaks the electrical connection between power source 11 and locking device 5. Other ways of extending connecting member 7 into receiving member 9 can be utilized as well.

A computer 15 can be connected to switch means 13 and each time switch means 13 makes a connection between power source 11 and locking device 5, because authorized keystrokes are entered into the keypad, a signal is sent from switch means 13 to computer 15 so that computer 15 can create a log of the time, date, and person accessing fuel dispenser 1. Computer 15 can either be located in the interior of fuel dispenser 1 or outside of fuel dispenser 1. The log in the form of a file can be saved to memory connected to computer 15, and/or the log can be printed directly to a printer. The log can also be displayed on a display connected to computer 15.

An intruder sensing device can also be placed within fuel dispenser 1 so that if there is an illegal entry, a signal will be sent to computer 15 and the entry will be added to the log of access times for fuel dispenser 1.

The present invention, in yet another form, comprises a method of using an electronic door lock with a fuel dispenser.

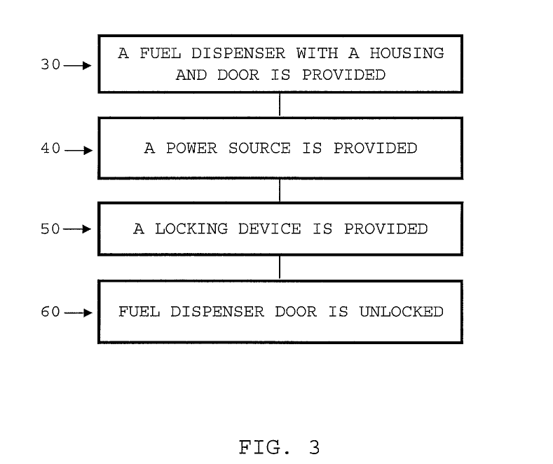

Turning to FIG. 3, the method of invention is shown including the step of providing (30) a fuel dispenser with a housing and door. Furthermore, the step of providing (40) a power source as well as providing (50) a locking device is shown. The locking device has a connecting member that extends into a receiving member. The receiving member has an opening for engagement with a connecting member and upon engagement with the connecting member, the door on the fuel dispenser is in the locked position. The locking device can be located on either the door or the housing. If the locking device is located on the door, the receiving member is located on the housing. If the locking device is located on the housing, the receiving member is located on the door.

The locking device has a solenoid around the surface of the connecting member. The locking device is connected to a switch means, which in turn, is connected to a power source. The switch means is used to either make or break the electrical connection between power source and the locking device.

The locking device is generally in the locked position, consisting of the connecting member extending into the receiving member. To access the interior of the fuel dispenser, authorized keystrokes are entered into the keypad located on the fuel dispenser thereby causing a switch means to create an electrical connection between the power source and the locking device. The power from the power source is applied to the solenoid around the connecting member causing the connecting member to retract from the receiving member and therefore unlocking (60) the fuel dispenser door. The locking device can use a biasing means to extend the connecting member into the receiving member once the switch means breaks the electrical connection between the power source and the locking device causing the door to become locked again.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An electronic door lock for a fuel dispenser comprising:
a fuel dispenser having a housing;
a door connected to one of said fuel dispenser;
a power source;
a locking device connected to one of said housing and said door, said locking device having a connecting member selectably extending into a receiving member on the other of said housing and door; and
a switch means for creating an electrical connection between said power source and said locking device causing said connecting member to retract from said receiving member.

2. The electronic door lock in claim 1, wherein said switch means is a signal receiving device.

3. The electronic door lock in claim 1, wherein said switch means is a keypad.

4. The electronic door lock in claim 2, wherein said signal receiving device receives a signal from a remote device.

5. The electronic door lock in claim 1, wherein said locking device is a plunger lock.

6. The electronic door lock in claim 1, wherein said power supply uses a battery backup.

7. The electronic door lock in claim 1, wherein said fuel dispenser uses an intruder sensing device.

8. The electronic door lock in claim 1, wherein said switch means is connected to a computer and said computer stores the time and date when said switch means creates an electrical connection between said power source and said locking device.

9. An electronic door lock for a fuel dispenser comprising:
a fuel dispenser having a first door and a second door;
a power source;
a locking device connected to one of said first door and said second door, said locking device having a connecting member selectably extending into a receiving member on the other of said first door and second door; and
a switch means for creating an electrical connection between said power source and said locking device causing said connecting member to retract from said receiving member.

10. The electronic door lock in claim 9, wherein said switch means is a signal receiving device.

11. The electronic door lock in claim 9, wherein said switch means is a keypad.

12. The electronic door lock in claim 10, wherein said signal receiving device receives a signal from a remote device.

13. The electronic door lock in claim 9, wherein said switch means is connected to a computer and said computer stores the time and date when said switch means creates an electrical connection between said power source and said locking device.

14. A method of using an electronic door lock with a fuel dispenser, the method comprising:
providing a fuel dispenser with a housing and a door;
providing a power source;
providing a locking device connecting to one of said housing and said door wherein said locking device has a connecting member selectably extending into a receiving member on the other of said housing and door; and
unlocking said door using a switch means with said fuel dispenser for creating an electrical connection between said power source and said locking device causing said connecting member to retract from said receiving member.

15. The method in claim 14, wherein said switch means is a signal receiving device.

16. The method in claim 14, wherein said switch means is a keypad.

17. The method in claim 15, wherein said signal receiving device receives a signal from a remote device.

18. The method in claim 14, wherein said power supply uses a battery backup.

19. The method in claim 14, wherein said fuel dispenser uses an intruder sensing device.

20. The method in claim 14, wherein said switch means is connected to a computer and said computer stores the time and date said switch means creates an electrical connection between said power source and said locking device.
